(19) United States
(12) Patent Application Publication
(10) Pub. No.: US 2010/0072325 A1
(43) Pub. Date: Mar. 25, 2010

(54) Forward (Upstream) Folding Rotor for a Vertical or Short Take-Off and Landing (V/STOL) Aircraft

(76) Inventor: Kenneth William Sambell, Arlington, TX (US)

Correspondence Address: Richard J. Steeno, 3114 Summer Grove Ct., Mansfield, TX, 76063, US

(21) Appl. No.: 12/356,585

(22) Filed: Jan. 21, 2009

Related U.S. Application Data
(60) Provisional application No. 61/011,687, filed on Jan. 22, 2008.

(51) Int. Cl. B64C 27/22; B64C 29/00

(52) U.S. Cl. 244/7 A

(57) ABSTRACT

This is an improvement of the 1968 Trailing Rotor V/STOL aircraft (Ref. 1). Rotors are mounted on wing-tip pods which can be tilted from the vertical to the horizontal aft position. Rotors are then stopped in the axial-flow condition and indexed to an azimuth position, aft of the wing trailing-edge. Rotor blades are then folded forward (blade-tips upstream of rotor-hubs) and locked into grooves in the tip-pods.

The main improvements over Ref. 1 are: a smaller shift of center-of-gravity during transition to cruise mode, and an easier task of locking blades into the tip-pods.

The main feature of the autorotative aft rotor tilt is that a soft-inplane rotor can be used, which reduces rotor weight. The blade-folding axis is also the blade-flapping axis.

The autorotative mode is used frequently by helicopters during descent. It has been found to be a good, stable mode with rpm-stability. During aft tilt on the UFR, the rotors provide pitching stability to the airframe. During stopping of the rotor, the stability of the autorotating rotor eases the task of passing thru rotor resonance.

Also, the wing can be swept back, which is desirable for 400 kt. cruise speeds and can be used for external stores such as fuel and weapons.

### CROSS-REFERENCE TO RELATED APPLICATIONS

| | | | |
|---|---|---|---|
| Ref. 1 | 3,404,852 | 10/1968 | Sambell et al |
| Ref. 2 | 5,085,315 | 2/1992 | Sambell |

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

This invention is a member of the well known Tilt-Rotor family of vertical or short take-off and landing (V/STOL) aircraft. It is a variant of the folding tilt-rotor aircraft of Ref. 1, of which I am a co-inventor. The most successful version of this family of aircraft is the Bell Helicopter Osprey (V-22) manufactured by Bell Helicopter. The V-22 has proved the viability of the concept of using rotary thrust for vertical take-off and then tilting of the rotors forward to provide forward/horizontal thrust in combination with fixed wing lift. Traditionally, helicopter aircraft cannot travel at speeds exceeding 180kt. The V-22 specifies a top speed around 300kt.

Previously, Ref. 1 disclosed an attempt to overcome the speed limitations of a pure tilt rotor aircraft system by allowing the rotor blades to be gradually tilted aft in concert with the jet engines taking over forward thrust requirements. The rotor blades were disclosed to then stop rotation and fold aft (trailing) and allowing the jet engines to provide all forward thrust. The previous invention of Ref.1, however, suffered from several design flaws which likely would have proved problematic during prototyping. First, the aft folding of the rotors would cause a large center of gravity shift toward the rear of the craft which would impose additional control requirements and possible instabilities. Second, the aft folding rotors would require additional hardening and lengthening of the pylons to prevent rotor flapping and instability in the trailing position from normal air turbulence. Additionally, hydraulic actuators would be required in a rotating system with rotors folded aft; these hydraulic actuators are less reliable and prone to wear and leakage due to rotational and centrifugal forces.

This invention overcomes the limitation of the Ref. 1 patent while still providing the benefits over traditional tilt-rotor aircraft sought in the previous art.

### BRIEF SUMMARY OF THE INVENTION

The invention follows the basic concept of using tilt rotors to provide lift and forward thrust similar to aircraft such as the V-22. This invention adds the benefits of:

1. A system for transitioning from rotor thrust to jet thrust by tilting and stopping the rotors during flight.

2. A system for indexing, folding the rotors forward along the pylons and securing them in slots along the pylons.

3. A system for controlling the pitch angle of the rotor-blades, the tilt angle of the pylons and the indexing of the blades so as to provide for a stable transition from rotor-borne flight to fixed-wing flight.

4. A system which is also capable of reversing the process from fixed-wing flight to rotor-borne flight.

This invention discloses a further attempt to increase the capabilities of the tilt-rotor concept. Specifically, this invention discloses a system which will allow the aircraft to use rotary thrust for vertical take-off and sub-fixed wing stall speed and jet engines for speeds not only above fixed wing stall speed but also speeds above those possible with conventional rotary or propeller thrust. This invention improves over prior art by offering a top speed of approximately 400 kts. This higher speed is achieved by tilting the pylons aft and then folding the rotor-blades forward (upstream) into a stored position along the axis of the engine pylons allowing the jet engines to exclusively provide forward thrust. The rotors will achieve a stored position in groves along the pylons, reduce or eliminate CG shift and acting as endplates to provide reduced drag on the wings.

### BRIEF DESCRIPTION OF THE SEVERAL VIEWS OF THE DRAWING

FIG. 1. Take-off configuration in rotary-wing mode.

FIG. 2. Cruise configuration in fixed-wing mode.

FIG. 3. Hub and blade, perspective view.

FIG. 3A. Blade fold-horn

FIG. 4A. Blade fold system

FIG. 4B. Blade-pitch system

FIG. 5A. Rotor-blade folding into tip-pod

FIG. 5B. Blade-lock system in tip-pod

### DETAILED DESCRIPTION OF THE INVENTION

This concept is a member of the well known Tilt-Rotor family of vertical/short take-off aircraft. It is a variant of the folding tilt-rotor aircraft of Ref. 1, of which I am co-inventor.

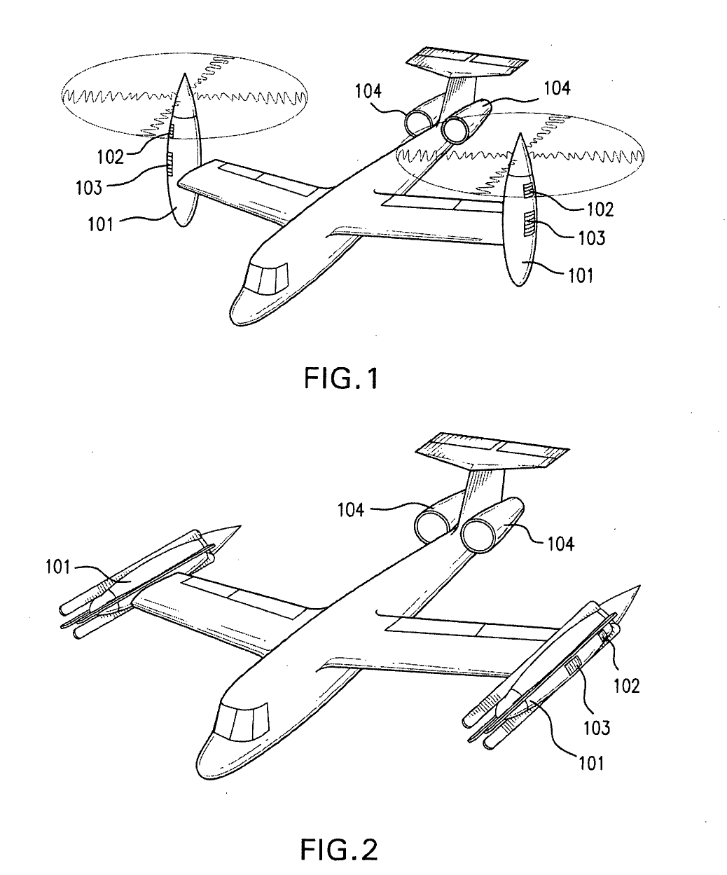

### A. TAKE-OFF CONFIGURATION FIG. 1

Rotors (4 bladed in this embodiment) are mounted on tip-pods 101 at the wing-tips, inter-connected by the usual shaft-drive. Rotor axes can tilt from 30 deg. forward of vertical to 90 deg. aft of vertical. Rotors are driven by shaft-engines mounted in the tip-pods. Inlet air enters thru streamlined louvers 102. Exhaust air exits thru the lower louvers 103. These louvers are closed in cruise flight into a low-drag streamlined position.

Additional engines 104 are mounted at the rear of the fuselage. These engines are used during transition and cruise flight and are at idle thrust during vertical take-off.

### B. CRUISE CONFIGURATION FIG. 2

The rotor blades are folded into the tip-pods and locked securely. The shaft-engines are stopped and all louvers closed. The cruise-engines supply cruise thrust.

The tip-pods act as end-plates to the wing and reduce drag.
Cruise speeds of 400-450 Kt. Are possible with good lift-drag ratios.

### C. CONVERSION FROM TAKE-OFF TO CRUISE CONFIGURATION

Vertical take-off is achieved with rotor axes vertical and rotors rotating at 100% rpm. Rotor- borne flight extends from hover to 150 Kt. Wing-stall speed is 120 Kt.
1. At 140 Kt., the cruise-engine thrust is increased and the rotors enter autorotation (cyclic pitch is moved aft).
2. Rotor axes are tilted 90 deg. aft to the horizontal position. Rotor tip-speed is reduced concurrently to 50% rpm. Lift is transferred ,at same time, from the rotors to the wing.
3. Next, rotors are “feathered” (collective pitch at −90 deg.) and stopped and indexed so that the rotor-blades clear the wing (45 deg. either side of horizontal for a 4-bladed rotor). Rotor brake is applied to prevent rotation.
4. Blades are folded forward (tips upstream of hub) and locked into grooves in the tip-pods. Locking pins secure the blades thru lugs on each blade.
5. When all locking pins are locked and secure, the shaft-engines are stopped, and all louvers are closed.
6. The aircraft may now be accelerated to cruise speed.

### D. RE-CONVERSION TO ROTOR-BORNE FLIGHT

1. This is the reverse of the above.

2. Vertical landings may be made with the rotors powered, or in an emergency, rolling landings may be made with the rotors autorotating (unpowered) and with the cruise engines operating to achieve safe descent rates.

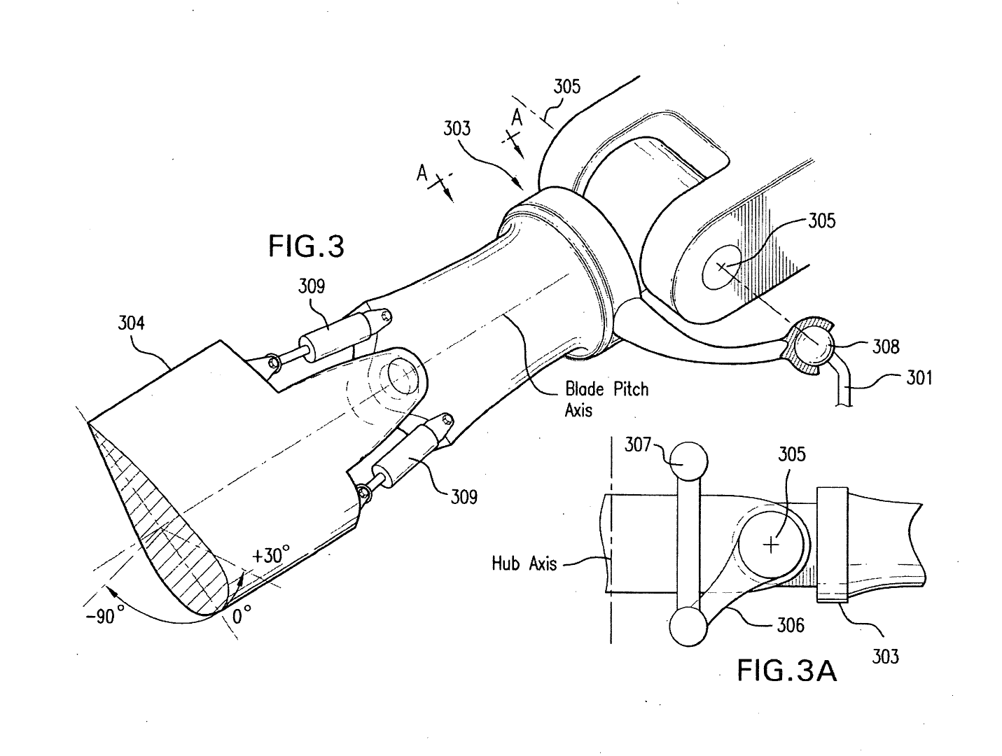

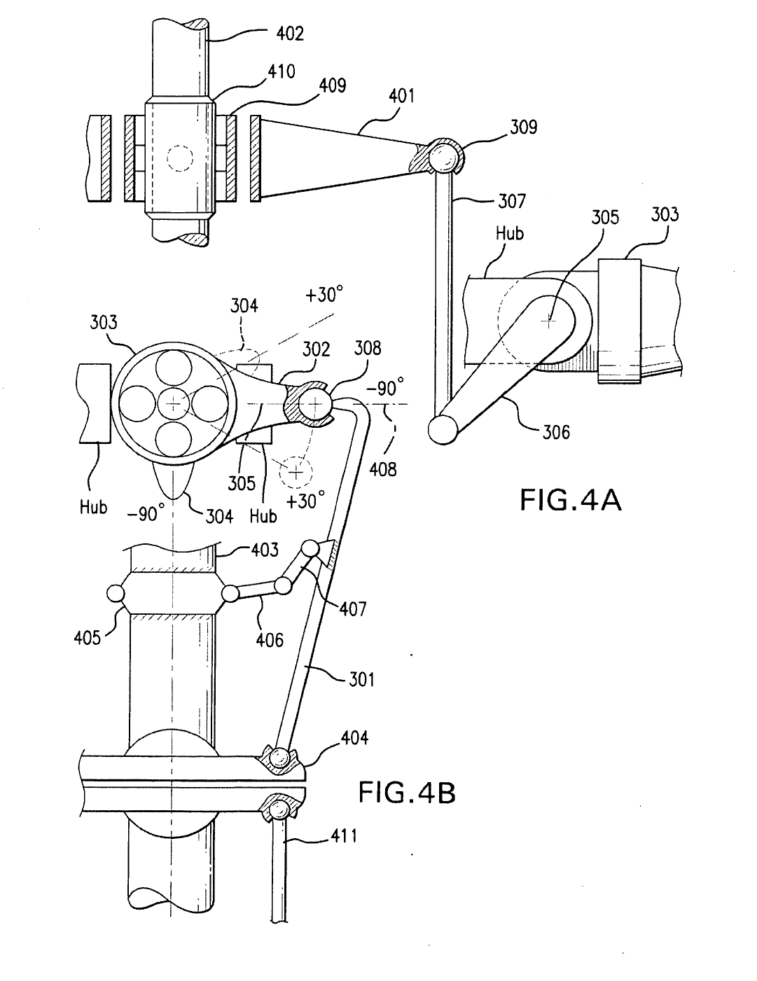

### E. ROTOR-HUB DESCRIPTION FIGS. 3 and 4

The rotor is soft-inplane (1^{st}. in-plane frequency less than 1 per rev.) with a flapping hinge 305 and lead-lag hinge. The flapping hinge is also the blade-fold hinge.

The following blade angles are provided:

(a) Collective pitch +30 deg. to −90 deg. (helo. max to aft feather)

(b) Cyclic pitch +12 deg. to −12 deg.

(c) Folding +20 deg. to −90 deg. (max. up to forward fold)

FIG. 4B, Inputs from a conventional swashplate 411, 404 go to the pitch-link 301 which has a ball-joint connection 308 to the pitch horn 302 which has a star-gearbox 303 attached. The gear-box has a 3:1 ratio which amplifies a 40 deg. pitch-horn motion to a 120 deg. motion of blade 304. The flapping axis and fold axis 305 allow cyclic motion of + & −12 deg in rotor-borne flight and blade folding of +20 deg. to −90 deg. in conversion.

The ball-joint 308 is shown at a collective pitch of −90 deg., co-incident with fold axis 305, prior to folding.

Ball-joint 308 is also shown (dashed) at a collective pitch of +30 deg. (upper limit in helo. mode). Nose of blade 304 is shown (dashed) at +30 deg., and also at −90 deg. Note that the star-gear system reverses the sense of rotation between the pitch horn and the rotor blade.

The ball joint 308 has a goose neck which has an axis 408 which is co-incident with axis 305 prior to folding (collective pitch −90 deg.) This alignment is maintained by clevis joints on links 406, 407. Link 406 is attached to a clevis on collar 405 which is attached securely to rotor mast 403. The outer end of 407 is attached to a clevis on pitch-link 301. Thus alignment is preserved by this clevis system without impeding the pitch-change motion of 301.

Folding mechanism: FIG. 3A & 4A.

The fold horn 306 is centered on the fold axis 305 and is controlled by the fold link 307 and by a folding yoke 401 which synchronizes the folding of all blades.

Prior to folding, the center of ball-joint 308 is co-incident with fold axis 305 (−90 deg.collective pitch) and as the blade is folded into the tip-pod, there is no change of blade-pitch.

Fold link 307 has ball joint 309 attached to folding yoke 401 which is attached to double-gimbal ring 409 attached to collar 410 which is rigidly attached to folding slide-shaft 402 which slides inside the rotor-mast 403. The slide—shaft 402 is connected to a known push-pull thrust bearing (not shown) which is connected to a folding actuator at the bottom of the main gear-box in the non-rotating system.

Thus in helicopter flight, the yoke 401 allows each blade to flap individually (responding to cyclic pitch) and, since the folding actuator is not pressurized, yoke 401 also allows coning motion of all blades (responding to collective pitch), as slide-shaft 402 slides up and down inside rotor-mast 403.

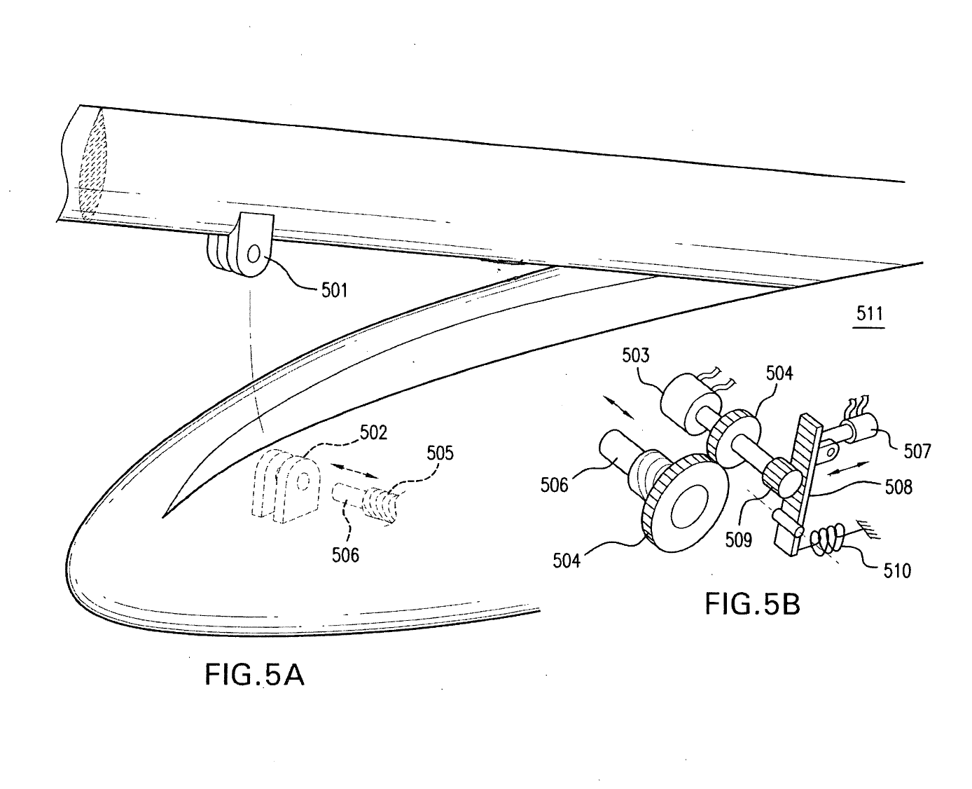

### F. BLADE LOCKING SYSTEM FIG. 5A & 5B

The blades are locked into grooves in the tip-pods 511 by hydraulic actuators. Each blade has lugs 501 which extend from the blade nose. Matching lugs 502 are mounted in the tip-pod. Hydraulic motor 503 drives the reduction gears 504 and screwthread 505 to locking pin 506. A mechanical safety-lock consists of hydraulic actuator 507, mechanical rack 508, pinion 509 and spring 510.

When 503 is pressurized, 507 unlocks 508,509 to allow pin 506 to secure the blade.

When 503 and 507 are unpressurized, spring 510 engages the mechanical lock 508,509. Screwthread 505 is the primary safety feature backed up by the rack and pinion 508,509.

### G. ROTOR HYDRAULIC-DAMPING & -LOCKS

This in-flight stoppable rotor has hydraulic features (of known technology) to minimize blade motions in gusts.

During conversion, with the rotor axes at +90 deg., and the blades windmilling aft of the wing trailing-edge, air-drag on the blades will cause all blades to flap at +5 deg. This is also called a coning angle of +5 deg.

As the rpm drops below 20% , the hydraulic fold actuator increases damping (by flow restrictors) and locks coning at +5 deg. When the rotor has stopped and indexed, folding pressure is activated to fold the blades.

There is a mechanical stop on the fold actuator shaft at +20 deg.coning to prevent large blade motions. The above sequence is reversed during unfolding and rotor spin-up.

### H. BLADE HYDRAULIC-DAMPING & -LOCKS

The lead-lag dampers 309 on each blade have features of known technology to aid stopping in flight.

In helicopter mode, blade motion is damped as the blade oscillates + and −5 deg. from the radial position, in the plane of rotation.

As the rotor rpm drops below 20%, centrifugal sensors increase damping (by flow restrictors) and lock each blade in the radial (or slightly aft) position. The blades are then in the correct position for indexing and folding.

The above sequence is reversed during unfolding

I claim:

1. A tilt-rotor aircraft in which the rotor pylon(s) convert aft from a substantially vertical position to a substantially horizontal position, wherein the pylon axis is substantially parallel to the fuselage horizontal datum.

2. The device of claim 1 further comprising a system in which the rotor-blades are stopped, indexed, and folded forward to be substantially parallel to the pylon axis. The blade-tips are pointed forward (upstream) from the folding axis.

3. The device of claim 1 further comprising a system in which Rotor-blades, having been folded forward, are locked securely, leading-edge inwards, into slots along the pylons.

4. The device of claim 1 further comprising the combination of shaft-engine(s) mounted on the rotor- pylon(s), together with the forward-folding blades. Said shaft-engines may have their exhaust-ducts up, or down (when pylon is vertical), said engines are substantially buried in the blade-pod(s).

3. The device of claim 1 further comprising spacing around the rotor azimuth between blades in a non-uniform configuration to achieve a low blade-pod drag in cruise flight. For a four-bladed rotor the spacing may be:
(a) Between blades #1 & #2, 70-90 degrees.
(b) Between blades #3 & #4, 70-90 degrees.
